(19) United States
(12) Patent Application Publication
(10) Pub. No.: US 2018/0004955 A1
(43) Pub. Date: Jan. 4, 2018

(54) Method for Secure Operation of a Computer Unit, Software Application and Computer Unit

(71) Applicant: Giesecke+Devrient Mobile Security GmbH, München (DE)

(72) Inventor: Frank SCHÄFER, Puchheim (DE)

(21) Appl. No.: 15/542,577

(22) PCT Filed: Jan. 7, 2016
(86) PCT No.: PCT/EP2016/000020

§ 371 Date: Jul. 10, 2017

(30) Foreign Application Priority Data
Jan. 8, 2015 (DE) 10 2015 000 220.1

(51) Int. Cl. G06F 21/57; G06F 21/31

(52) U.S. Cl. CPC G06F 21/575; G06F 21/31

(57) ABSTRACT

A method for operating a computer unit having a processor on which a software application can run comprises the steps: upon invoking the software application or upon carrying out a transaction with the software application on the computer unit the step of checking whether the computer unit has been restarted since the last invoking of the software application; carrying out a first form of authentication for starting the software application or for carrying out the transaction with the software application if the computer unit has not been restarted since the last invoking of the software application; and carrying out a second form of authentication for starting the software application or for carrying out the transaction with the software application if the computer unit has been restarted since the last invoking of the software application. Further provided are a correspondingly designed software application as well as a correspondingly designed computer unit.

### FIELD OF THE INVENTION

The invention relates to a method for securely operating a computer unit having a software application as well as such a software application and such a computer unit. In particular the invention relates to a method for securely operating a mobile end device having a software application as well as such a software application and such a mobile end device.

### BACKGROUND OF THE INVENTION

Mobile end devices in the form of smartphones are increasingly being used to carry out digital transactions, for example for cashless payments at a NFC terminal or for the purchase of goods or services from an online retailer. Upon carrying out such a digital transaction, as a rule a software application implemented on the smartphone (briefly called “app”) interacts with a terminal or server. The software application is usually secured by the fact that the user must authenticate vis-à-vis the mobile end device or the server by means of a PIN or another authentication means for starting the software application and/or for carrying out the digital transaction. Frequently, a cryptographic algorithm, for example an encryption algorithm, is part of the software application implemented on the mobile end device, which accesses security-critical data, e.g. PINs, passwords, keys etc. In the past, security-critical data as a rule have been deposited on a stand-alone security element of the mobile end device, frequently in the form of a SIM card removable from the mobile end device, to protect these from an attack by an unauthorized person.

A newer approach, which can be used advantageously in particular upon carrying out digital transactions with a mobile end device which has no stand-alone hardware security element for securely storing security-critical data, is based on the idea of protecting applications by means of software measures, for example by hiding security-critical data in the program code of an application such that these are not extractable for an attacker.

Such an approach with a software security element does, however, have a security hole. If an attacker, for example, wants to find out the PIN for unlocking or for carrying out a digital transaction by means of the software application, he or she can proceed as follows. Prior to the PIN query by the software application, the current state of the mobile end device is frozen by creating and storing a memory image (“image”). Then the attacker tries out the first PIN in reaction to the PIN query. If the access to the software application is not granted on account of a wrong PIN tried out by the attacker, the attacker can reload the image created before the PIN query onto the mobile end device and try out a new PIN until the right PIN has been guessed and the access to the PIN-protected software application has been granted.

The skilled person will recognize that a PIN operating error counter implemented in software, as this is known from hardware security elements to disable the security element after a predefined number of wrong PIN entries, would be ineffective for the attack described hereinabove because upon the renewed loading of the image onto the mobile end device, an operating error counter implemented in the software is again reset to the value which it had before the PIN query each time.

Against this background there arises the object of supplying an improved method for operating a computer unit, preferably in the form of a mobile end device, as well as such a computer unit, preferably in the form of a mobile end device, with which the attack described hereinabove can be prevented.

### SUMMARY OF THE INVENTION

The hereinabove object is achieved according to the present invention by the respective subject matter of the independent claims. Preferred embodiments of the invention are stated in the dependent claims.

According to the first aspect of the invention a method is provided for operating a computer unit having a processor on which a software application can run. The fact that the software application can run on the processor is attained by the software application being implemented on the computer unit such that when put into operation it runs on the processor. For this, the method comprises the following steps: upon invoking the software application or upon carrying out a transaction with the software application on the computer unit, the step of checking whether the computer unit has been restarted since the last invoking of the software application; carrying out a first form of authentication for starting the software application or for carrying out the transaction with the software application if the computer unit has not been restarted since the last invoking of the software application; and carrying out a second form of authentication for starting the software application or for carrying out the transaction with the software application if the computer unit has been restarted since the last invoking of the software application.

In the above-described attack, a memory image (“image”) of the current state of a computer unit, which has been created before a PIN query by a software application of the computer unit and has been stored, is reloaded into the computer unit after the PIN query. To be able to carry out a new PIN query with the newly loaded image, the computer unit must be restarted. With the invention, such a restart of the computer unit is recognized, interpreted as a reason for suspecting an attack, and used as a trigger for a modified form of the authentication. Therefore, the computer unit can intercept a possibly effected attack with a modified form of authentication and, for example, prevent further PIN queries as needed.

According to preferred embodiments of the invention, the second form of authentication is stronger from a security standpoint than the first form of authentication.

Preferably, the first form of authentication comprises entering a PIN or a password.

The second form of the authentication can comprise electively entering a longer PIN or a more secure password. According to preferred embodiments of the invention, the second form of authentication comprises an authentication vis-à-vis a separate hardware element, e.g. a cloud server and/or an authentication by means of a hardware token, preferably a smart card. By integrating an additional hardware element (e.g. a cloud server or hardware token (particularly a smart card)) for the second form of the authentication, the security level of the authentication is increased in the case of a possibly effected attack.

Preferably it is checked whether the computer unit has been restarted since the last invoking of the software application by: the software application detecting if the same is called up after a restart of the computer unit; there being set up on the computer unit a broadcast mechanism which after a restart of the computer unit informs the software application registered with the broadcast mechanism about the restart of the computer unit; and/or the software application is so designed that upon the initial invoking of the software application the same starts a service which is never ended during operation of the mobile end device and that it can be checked whether the service is running or not.

According to a second aspect of the invention, a software application is supplied which is designed to run on the processor of a computer unit. For this, the software application is further designed for: checking, upon invoking the software application or upon carrying out a transaction with the software application on the computer unit, whether the computer unit has been restarted since the last invoking of the software application; requesting a first form of authentication for starting the software application or for carrying out the transaction with the software application if the computer unit has not been restarted since the last invoking of the software application; and requesting a second form of authentication for starting the software application or for carrying out the transaction with the software application if the computer unit has been restarted since the last invoking of the software application.

According to preferred embodiments of the invention, the second form of authentication is stronger from a security standpoint than the first form of authentication.

Preferably, the first form of authentication comprises entering a PIN or a password.

According to preferred embodiments of the invention, the second form of authentication comprises an authentication vis-à-vis a cloud server and/or an authentication by means of a hardware token, preferably a smart card.

Preferably the software application is designed for checking upon invoking the software application on the computer unit, whether the computer unit has been restarted since the last invoking of the software application, by: the software application detecting if the same is called up after a restart of the computer unit; there being set up on the computer unit a broadcast mechanism which after a restart of the computer unit informs the software application registered with the broadcast mechanism about the restart of the computer unit; and/or the software application is so designed that upon the initial invoking of the software application the same starts a service which is never ended during operation of the mobile end device, and that it can be checked whether the service is running or not.

According to the third aspect of the invention, there is provided a computer unit having a processor on which a software application can run, wherein the computer unit is designed for being operated by a method according to the first aspect of the invention.

According to the fourth aspect of the invention, there is provided a computer unit having a processor on which a software application runs according to the second aspect of the invention.

Preferably the computer unit according to the third or the fourth aspect of the invention is designed as a mobile end device, preferably as a smartphone.

Further features, advantages and objects of the invention will emerge from the following detailed description of several embodiment examples and embodiment alternatives. Reference is made to the drawing, in which there is shown:

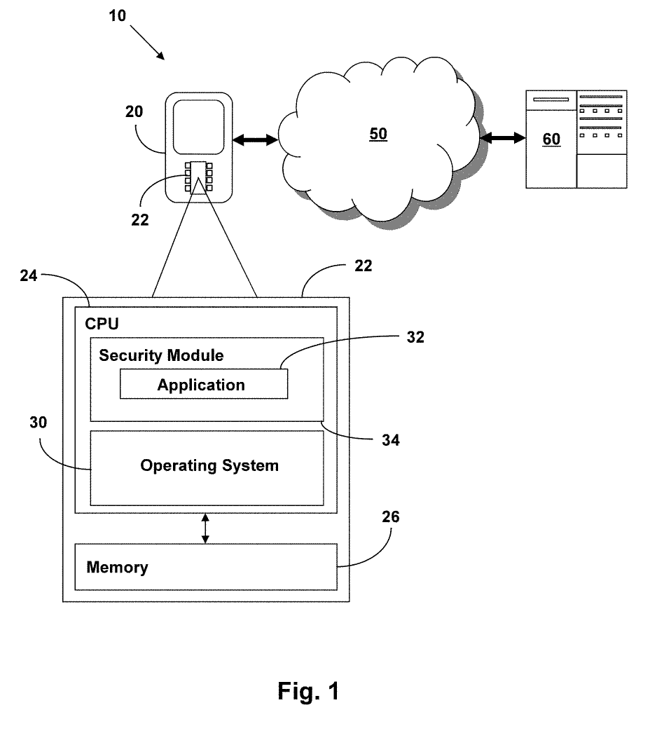

FIG. 1 a schematic representation of a communication system having a computer unit in the form of a mobile telephone for which the present invention is used advantageously.

FIG. 1 shows a schematic representation of an exemplary communication system 10 for which the invention can be used advantageously. The communication system 10 comprises a computer unit 20 in the form of a mobile end device, preferably in the form of a smartphone or mobile telephone. The mobile end device 20 is designed for communicating with a server or a terminal 60 over a communication channel 50. The communication channel 50 can, for example, be the Internet, a mobile radio network, an NFC channel or the like. The server 60 is devised, for example, as an NFC terminal of a service provider with whom a software application, for example the software application 32 on the mobile end device 20 can carry out transactions, e.g. a payment transaction for which the software application on the mobile end device 20 processes a payment operation.

The mobile end device 20 has a chip 22 having a central processing unit (CPU), for example in the form of a microprocessor 24. The primary objects of the processor 24 include executing arithmetic and logical functions, and reading and writing data elements according to the program code of a software applications running on the processor 24. For clarity's sake, a preferred architecture of the chip 22 is represented again schematically in detail in FIG. 1 outside of the mobile end device 20.

The processor 24 is in communication connection with a memory unit 26 which preferably comprises a volatile working memory (RAM), for example for receiving the program code of a software applications to be executed on the processor 24. Preferably the memory unit 26 further comprises a non-volatile, preferably re-writable memory to receive, for example in the unenergized state of the mobile end device 20, the program code to be executed by a software applications to be executed on the processor 24. Preferably, the non-volatile, re-writable memory is a flash memory (flash EEPROM). It may, for example, be a flash memory with a NAND or a NOR architecture. The memory unit 26 can, of course, also comprise a read only memory (ROM).

As is schematically represented in FIG. 1, an operating system 30 is implemented in the processor 24 at runtime such that the software application 32, for example a payment application, can access functions supplied by the operating system 30, such as a file system. According to the invention, a security module 34 implemented in the software is further present on the processor 24 at runtime, which safeguards the interaction with the software application 32. The program code of the operating system 30, the software application 32 and/or the security module 34 implemented in the software can be deposited in a non-volatile region of the memory unit 26.

According to the invention, the security module 34 is designed to implement the following security mechanism. During the normal operation, carrying out an action with the software application 32, e.g. accessing the software application and/or confirming an electronic transactions to be carried out with the software application 32, requires the first form of authentication by the user, preferably entering a PIN. If, however, it has been detected that the mobile end device 20 has been restarted, the security module 34 or the software application 32 requires a second form of authentication. Preferably, the second form of authentication is stronger from a security standpoint than the first form of authentication. In this connection, stronger means, for example, that when the first form of authentication consists of a PIN having four digits, the second form of authentication consists of a PIN having more than four digits. According to an alternative embodiment, the second form of authentication requires that the user of the mobile end device must authenticate vis-à-vis a cloud server, for example by entering a PIN or a password. According to a further, alternative embodiment, the second form of authentication can involve that the user authenticates by proving the possession of a hardware token, e.g. a smart card.

There are several possibilities for recognizing the restart of the mobile end device 20. The software application 32 can itself recognize when it is called up after a restart. As is known to the skilled person, there is for example in the Android operating system a so-called Callback for this purpose, which in fact is invoked upon every restart of the software application 32, yet hardly happens with the Android operating system. A further possibility consists in the fact that a broadcast mechanism is set up on the mobile end device 20 which, after a restart of the mobile end device 20, informs all applications registered with the broadcast mechanism about the restart of the mobile end device 20. Still another possibility provides that the software application 32 is so designed that upon the first-time starting of the software application 32, the same starts a service which is never ended during operation of the mobile end device. If the software application 32 detects that this service is not running, according to the invention the (preferably stronger) second form by authentication is requested and thereupon the service restarted. Otherwise, if the software application detects that the service is running, merely the (preferably weaker) first form by authentication is requested. Of course, the hereinabove described possibilities for recognizing a restart of the mobile end device 20 by the software application 32 can also be combined with each other.

1-11. (canceled)

12. A method for operating a computer unit having a processor on which a software application can run, wherein the method comprises the following steps:
upon invoking the software application on the computer unit or upon carrying out a transaction with the software application, the step of checking whether the computer unit has been restarted since the last invoking of the software application;
carrying out a first form of authentication for starting the software application or for carrying out the transaction with the software application if the computer unit has not been restarted since the last invoking of the software application; and
carrying out a second form of authentication for starting the software application or for carrying out the transaction with the software application if the computer unit has been restarted since the last invoking of the software application.

13. The method according to claim 12, wherein the second form of authentication is stronger from a security standpoint than the first form of authentication.

14. The method according to claim 12, wherein the first form of authentication comprises entering a PIN or a password.

15. The method according to claim 12, wherein the second form of authentication comprises an authentication vis-à-vis a cloud server and/or comprises an authentication by means of a hardware token.

16. The method according to claim 12, wherein it is checked whether the computer unit has been restarted since the last invoking of the software application by:
the software application detecting if the same is called up after a restart of the computer unit; and/or
there being set up on the computer unit a broadcast mechanism which after a restart of the computer unit informs the software application registered with the broadcast mechanism about the restart of the computer unit; and/or
the software application being so designed that upon the first invoking of the software application the same starts a service which is never ended while the mobile end device is being operated and that it can be checked whether the service is running or not.

17. A software application which is designed for running on the processor of a computer unit, wherein the software application is further designed for:
upon invoking the software application or upon carrying out a transaction with the software application on the computer unit, checking whether the computer unit has been restarted since the last invoking of the software application;
requesting a first form of authentication for starting the software application or for carrying out the transaction with the software application if the computer unit has not been restarted since the last invoking of the software application; and
requesting a second form of authentication for starting the software application or for carrying out the transaction with the software application if the computer unit has been restarted since the last invoking of the software application.

18. The software application according to claim 17, wherein the second form of authentication is stronger from a security standpoint than the first form of authentication.

19. The software application according to claim 17, wherein the first form of authentication comprises entering a PIN or a password.

20. The software application according to claim 17, wherein the second form of authentication comprises an authentication vis-à-vis a cloud server and/or comprises an authentication by means of a hardware token.

21. The software application according to claim 17, wherein the software application is designed for checking upon invoking the software application on the computer unit whether the computer unit has been restarted since the last invoking of the software application, by:
the software application detecting if the same is called up after a restart of the computer unit; and/or
there being set up on the computer unit a broadcast mechanism which after a restart of the computer unit informs the software application registered with the broadcast mechanism about the restart of the computer unit; and/or
the software application being so designed that upon the first invoking of the software application the same starts a service which is never ended while the mobile end device is being operated and that it can be checked whether the service is running or not.

22. A computer unit, in particular mobile end device, preferably smartphone, having a processor on which a software application according to claim 17 can run, or wherein the computer unit is designed for being operated by a method for operating a computer unit having a processor on which a software application can run, wherein the method comprises the following steps:
upon invoking the software application on the computer unit or upon carrying out a transaction with the software application, the step of checking whether the computer unit has been restarted since the last invoking of the software application;
carrying out a first form of authentication for starting the software application or for carrying out the transaction with the software application if the computer unit has not been restarted since the last invoking of the software application; and
carrying out a second form of authentication for starting the software application or for carrying out the transaction with the software application if the computer unit has been restarted since the last invoking of the software application.
